(19) United States
(12) Patent Application Publication
(10) Pub. No.: US 2008/0070109 A1
(43) Pub. Date: Mar. 20, 2008

(54) Flat-shaped non-aqueous electrolyte secondary battery

(75) Inventor: Tetsuhito Oka, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/898,630

(22) Filed: Sep. 13, 2007

(30) Foreign Application Priority Data
Sep. 14, 2006 (JP) 2006-249027

(51) Int. Cl. H01M 2/02; H01M 6/00

(52) U.S. Cl. 429/162

(57) ABSTRACT

A flat-shaped non-aqueous electrolyte secondary battery of the present invention includes: an electrode body formed by opposing a positive electrode and a negative electrode while interposing a separator therebetween; an outer case for housing the electrode body; and a sealing plate for sealing an opening of the outer case, and an end part of the sealing plate is positioned inside the outer case. Besides, the sealing plate functions as a positive electrode terminal, the outer case functions as a negative electrode terminal, and a surface layer of the sealing plate in contact with the positive electrode is formed with a metal layer made of aluminum or aluminum alloy.

### BACKGROUND OF THE INVENTION

1. Field of the Invention

The present invention relates to a flat-shaped non-aqueous electrolyte secondary battery having excellent leakage resistance.

2. Description of Related Art

A flat-shaped non-aqueous electrolyte secondary battery, which generally is called a “coin cell” or “button cell”, has a structure in which, for example, as shown in FIG. 3, an electrode body composed of a positive electrode 3 and a negative electrode 5 that are opposed to each other with a separator 4 being interposed therebetween and a non-aqueous electrolytic solution are confined in a space formed by a sealing plate 1, an outer case 2, and a ring-shaped gasket 6. In a flat-shaped non-aqueous electrolyte secondary battery having the foregoing structure, the sealing plate 1 in contact with the negative electrode 5 functions as a negative electrode terminal, while the outer case 2 in contact with the positive electrode 3 functions as a positive electrode terminal.

In a battery of this type, in the case where a metal oxide that causes a positive electrode made of the metal oxide to have a potential of not less than 3.5 V when the battery is charged is used for forming the positive electrode, there is a possibility that a metal that forms the outer case 2 functioning as the positive electrode terminal would undergo oxidation. On the other hand, the outer case 2 is required to have a sufficient strength for being crimped with the sealing plate 1 with the ring-shaped gasket 6 being interposed therebetween. In a conventional flat-shaped non-aqueous electrolyte secondary battery, in order to achieve both of the prevention of the above-described oxidation and the provision of a satisfactory crimping strength, the outer case 2 is, as shown in FIG. 3, formed by using a clad material composed of a first metal layer 22 made of aluminum or aluminum alloy and a second metal layer 21 made of stainless steel in a manner such that the first metal layer 22 made of aluminum or aluminum alloy is on a battery internal side.

In the flat-shaped non-aqueous electrolyte secondary battery having the outer case 2 formed with the above-described clad material, however, the first metal layer 22 made of aluminum or aluminum alloy, forming the outer case 2, is likely brought into contact with moisture from the ambient air at an end 23 of the outer case 2, and corrosion sometimes occurs with aluminum or aluminum alloy. In this case, the corrosion of the first metal layer 22 made of aluminum or aluminum alloy likely occurs particularly at an interface with the second metal layer 21 made of stainless steel. Such corrosion results in leakage of non-aqueous electrolytic solution in the battery to the outside of the battery.

Various techniques for avoiding such a problem of leakage have been proposed. For example, JP 2005-166387 A discloses a technique of forming an oxide coating over a part of an internal aluminum surface of a positive electrode case (outer case). JP 2006-164599 A discloses a technique of a surface treatment with respect to an aluminum end face of the positive electrode case (outer case).

Such a technique, however, results in an increase in the number of steps in the battery manufacturing process, and possibly decreases the battery productivity. Therefore, there is the need for the development of a technique for improving the leakage resistance of the battery without impairing the productivity.

### SUMMARY OF THE INVENTION

With the foregoing in mind, it is an object of the present invention to provide a flat-shaped non-aqueous electrolyte secondary battery having excellent leakage resistance.

A flat-shaped non-aqueous electrolyte secondary battery of the present invention includes: an electrode body formed by opposing a positive electrode and a negative electrode while interposing a separator therebetween; an outer case for housing the electrode body; and a sealing plate for sealing an opening of the outer case, and an end part of the sealing plate is positioned inside the outer case, wherein the sealing plate functions as a positive electrode terminal, the outer case functions as a negative electrode terminal, and a surface layer of the sealing plate in contact with the positive electrode is formed with a metal layer made of aluminum or aluminum alloy.

### BRIEF DESCRIPTION OF THE DRAWINGS

FIG. 1 is a cross-sectional view illustrating principal parts of an exemplary flat-shaped non-aqueous electrolyte secondary battery of the present invention.

FIG. 2 is a cross-sectional view illustrating principal parts of another exemplary flat-shaped non-aqueous electrolyte secondary battery of the present invention.

FIG. 3 is a cross-sectional view illustrating principal parts of a conventional exemplary flat-shaped non-aqueous electrolyte secondary battery.

### DETAILED DESCRIPTION OF THE INVENTION

The flat-shaped non-aqueous electrolyte secondary battery of the present invention includes an electrode body formed by opposing a positive electrode and a negative electrode while interposing a separator therebetween, an outer case for housing the electrode body, and a sealing plate for sealing an opening of the outer case, wherein an end part of the sealing plate is positioned inside the outer case.

The sealing plate functions as the positive electrode terminal, the outer case functions as the negative electrode terminal, and a surface layer of the sealing plate in contact with the positive electrode is formed with a metal layer made of aluminum or aluminum alloy.

Unlike the outer case, the sealing plate has an end part positioned inside the outer case (inside the battery). Therefore, the end part of the sealing plate hardly is in contact with moisture in the ambient air. Therefore, in the present invention, by making the sealing plate function as the positive electrode terminal and configuring the sealing plate so that the surface layer thereof in contact with the positive electrode (the surface layer thereof on the internal side of the battery) is the first metal layer made of aluminum or aluminum alloy, the oxidation of the sealing plate in a charged state is prevented, while corrosion of aluminum or aluminum alloy at the end part of the sealing plate caused by contact with moisture in the ambient air is suppressed. In the battery of the present invention, with these effects, the leakage of the non-aqueous electrolytic solution to the outside of the battery is prevented, without an increase in the number of steps in the battery manufacturing process.

It should be noted that, in the battery industry, a flat-shaped battery having a diameter larger than a height thereof is called a “coin cell” or “button cell”, but there is no clear difference between the coin cell and the button cell. The category of the flat-shaped non-aqueous electrolyte secondary battery of the present invention includes both of the coin cells and the button cells. Besides, regarding the plan-view shape, the flat-shaped battery of the present invention is not limited to that having a round shape, and flat-shaped batteries having polygonal plan-view shapes such as rectangular shapes are also included in the foregoing category.

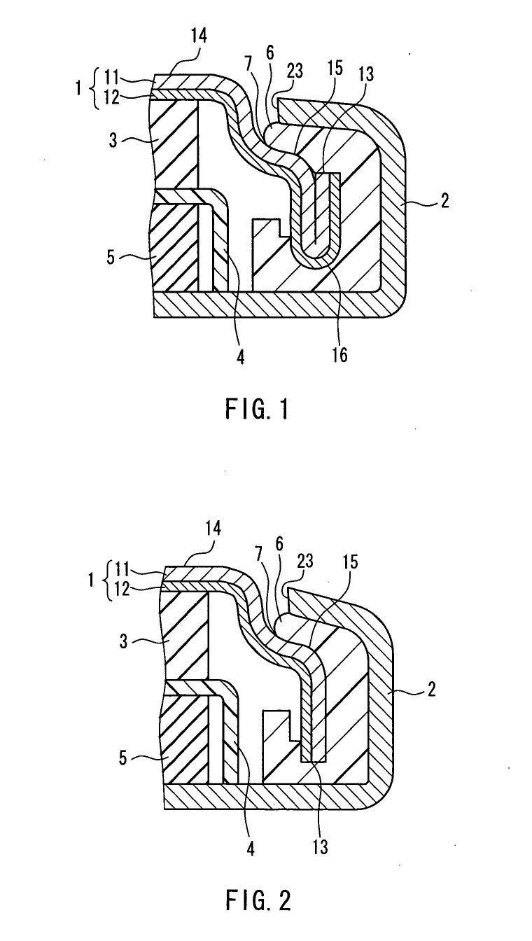

Hereinafter, embodiments of the flat-shaped non-aqueous electrolyte secondary battery of the present invention will be described with reference to the drawings. FIG. 1 is a cross-sectional view illustrating principal parts of an exemplary flat-shaped non-aqueous electrolyte secondary battery of the present invention. The battery shown in FIG. 1 includes an electrode body in which a positive electrode 3 and a negative electrode 5 are opposed with a separator 4 being interposed therebetween. The electrode body, together with a non-aqueous electrolytic solution (not shown), is confined in a space (sealed space) formed by a sealing plate 1, an outer case 2, and a ring-shaped gasket 6. The sealing plate 1 is fitted in an opening of the outer case 2 with the ring-shaped gasket 6 being interposed therebetween. An end part of the outer case 2 around the opening thereof is crimped inward, whereby the ring-shaped gasket 6 is brought into contact with the sealing plate 1. By so doing, the opening of the outer case 2 is sealed, whereby the internal part of the battery has a sealed structure.

Since the sealing plate 1 functions as a positive electrode terminal, an internal layer thereof (on the internal side of the battery) in contact with the positive electrode 3 is formed with a first metal layer 12 made of aluminum or aluminum alloy. Further, an external layer (on the external side of the battery) of the sealing plate 1 preferably is formed with, for example, a second metal layer 11 made of stainless steel or iron. Thus, the sealing plate 1 preferably is formed with a clad material composed of the first metal layer 12 made of aluminum or aluminum alloy and the second metal layer 11 made of stainless steel or iron.

As the aluminum alloy used for forming the first metal layer 12, an alloy of aluminum with, for example, Si, Fe, Cu, Mn, Mg, Zn, Cr, Ti, or the like is used. The thickness of the first metal layer 12 may be set to be 5 μm to 100 μm. The thickness of the second metal layer 11 may be set to be 100 μm to 300 μm.

The sealing plate 1 has, at a periphery thereof, a shoulder part 15 that is lower in a step-like form with respect to a top surface 14 of the sealing plate 1. In addition to this, the sealing plate 1 includes a wall part extending downward from the shoulder part 15 and then folded back at a fold 16 so that an end part 13 of the sealing plate 1 is directed upward.

As can be seen in FIG. 1, the end part 13 of the sealing plate 1 is positioned inside the outer case 2 (inside the battery), unlike an end part 23 of the outer case 2. Therefore, the end part 13 hardly is in contact with moisture in the ambient air. Consequently, the first metal layer 12 made of aluminum or aluminum alloy can be prevented from being corroded at the end part 13 because of contact with moisture in the ambient air, and this makes it possible to suppress leakage of non-aqueous electrolytic solution to the outside of the battery.

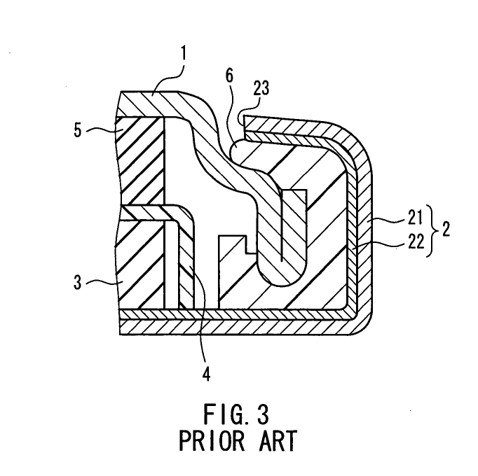

Further, FIG. 2 is a cross-sectional view illustrating principal parts of another exemplary flat-shaped non-aqueous electrolyte secondary battery of the present invention. In FIG. 2, the same portions as those in FIG. 1 are designated by the same reference numerals, and descriptions of the same are omitted in some cases.

As described above, the battery shown in FIG. 1 has, at the periphery thereof, the shoulder part 15 lower in a step-like form with respect to the top surface 14 of the sealing plate 1, and in addition to this, the wall part extending downward from the shoulder part 15 and then folded back at a fold 16 so that an end part 13 of the sealing plate 1 is directed upward. In contrast, in the battery shown in FIG. 2, a sealing plate 1 has, at a periphery thereof, a shoulder part 15 lower in a step-like form with respect to a top surface 14 of the sealing plate 1, and in addition to this, a wall part extending downward from the shoulder part 15 and terminating at an end part 13.

In other words, in the case of the battery shown in FIG. 1, there is a possibility that moisture from the ambient air could penetrate through a contact part 7 at which an upper end portion of the ring-shaped gasket 6 and the sealing plate 1 are brought into contact, whereas in the case of the battery shown in FIG. 2, the end part 13 of the sealing plate 1, which most likely is corroded because of contact with moisture from the ambient air, is positioned farther from the contact part 7 to which the ambient air likely penetrates, as compared with the battery shown in FIG. 1. Thus, the battery shown in FIG. 2 has a structure such that the end part 13 further less likely is brought into contact with moisture from the ambient air. Therefore, in the battery shown in FIG. 2, corrosion of the sealing plate 1 at the end part 13 can be suppressed more excellently, as compared with the battery shown in FIG. 1, and hence the leakage resistance can be enhanced further.

A fluorine-atom-containing lithium salt (will be described later in more detail) is used as a solute to be dissolved in the non-aqueous electrolytic solution in some cases with a view to further improving the battery properties of the flat-shaped non-aqueous electrolyte secondary battery, but when moisture inevitably is mixed in a non-aqueous electrolytic solution dissolving a fluorine-atom-containing lithium salt during the battery manufacturing process, hydrogen fluoride (HF) is generated in some cases. If hydrogen fluoride generated in the battery is in contact with the sealing plate 1 for a long time, the first metal layer 12 made of aluminum or aluminum alloy on the internal surface side of the sealing plate 1 is corroded sometimes. In this case, the battery having the structure shown in FIG. 1 has the following risk: if the first metal layer 12 made of aluminum or aluminum alloy is corroded at the fold 16 of the sealing plate 1 in particular, the sealing plate 1 and the ring-shaped gasket 6 loosen, and through the loosened portion, the non-aqueous electrolytic solution leaks out of the battery.

In contrast, in the case of the battery having the structure shown in FIG. 2, even if the first metal layer 12 made of aluminum or aluminum alloy in the sealing plate 1 is in contact with hydrogen fluoride generated in the battery for a long time, thereby being corroded partially, the second metal layer 11 made of stainless steel or iron in the sealing plate 1 prevents the sealing plate 1 and the ring-shaped gasket 6 from loosening, thereby suppressing the leakage of the non-aqueous electrolytic solution. Thus, the effect of the battery having the structure shown in FIG. 2, i.e., the battery having the sealing plate 1 that has, at the periphery, the shoulder part 15 lower in a step-like form with respect to the top surface 14 of the sealing plate 1, and further, the wall part extending downward from the shoulder part 15 and terminating at an end part 13, is exhibited more conspicuously in the case where a non-aqueous electrolytic solution obtained by dissolving a fluorine-atom-containing lithium salt in an organic solvent is used.

The positive electrode according to the flat-shaped non-aqueous electrolyte secondary battery of the present invention can be formed so as to exhibit an open circuit voltage of not less than 3.5 V measured by using metal lithium as a counter electrode in a state where the battery is charged. Used as the positive electrode may be, for example, an electrode formed by molding a positive electrode mixture containing a positive electrode active material, a conductive agent, and a binder.

The open circuit voltage of the positive electrode can be controlled by selecting the positive electrode active material used. Examples of the positive electrode active material that can be used include lithium-transition metal composite oxides such as LiₓCoO₂, LiₓNiO₂, LiₓMnO₂, LiₓCo_{y}Ni_{1-y}O₂, LiₓCo_{y}M_{1-y}O₂, LiₓNi_{1-y}M_{y}O₂, LiₓMn_{y}Ni_{z}Co_{1-y-z}O₂, LiₓMn₂O₄, LiₓMn_{2-y}M_{y}O₄. In each of the above-described lithium-transition metal composite oxides, M represents at least one metal element selected from the group consisting of Mg, Mn, Fe, Co, Ni, Cu, Zn, Al, and Cr; x satisfies 0≦x≦1.1; y satisfies 0<y<1.0; and z satisfies 2.0≦z≦2.2. Each of these positive electrode active materials may be used alone, or two or more of the same may be used in combination.

Examples of the conductive agent include carbon black, scaly graphite, Ketjen black, acetylene black, and fibrous carbon. Examples of the binder include polytetrafluoroethylene (PTFE), polyvinylidene fluoride (PVDF), carboxymethyl cellulose, and styrene butadiene rubber.

The positive electrode may be formed through the following steps: preparing a positive electrode mixture by mixing a positive electrode active material, a conductive agent, and a binder; and subjecting the positive electrode mixture thus prepared to pressure forming. Alternatively, the positive electrode may be formed through the following steps: preparing a positive electrode mixture-containing paste by dispersing the foregoing positive electrode mixture in water or an organic solvent (in this case, the positive electrode mixture-containing paste may be prepared by dissolving or dispersing a binder in water or the solvent preliminarily and mixing the obtained solution or dispersion with the positive electrode active material or the like); applying the positive electrode mixture-containing paste over a charge collector formed with a metal foil, an expanded metal, or a plain-woven metal wire net; drying the paste applied over the charge collector; and thereafter, subjecting the same to pressure forming. The method for forming the positive electrode, however, is not limited to the above-described ones: the positive electrode may be formed by another method.

A composition of the positive electrode preferably is such that, for example, the content of the positive electrode active material is 75 to 90 mass %, the content of the conductive agent is 5 to 20 mass %, and the content of the binder is 3 to 15 mass % with respect to the total amount by mass of the positive electrode mixture that forms the positive electrode.

As a negative electrode according to the battery of the present invention, a negative electrode that contains the following material as an active material may be used: lithium, lithium alloy, carbon materials that can intercalate and deintercalate lithium ions, lithium titanate, or the like.

Examples of the lithium alloy used in the negative electrode active material include lithium alloys that can occlude and release lithium reversely, such as lithium-aluminum alloy, and lithium-gallium alloy. In the lithium alloy, the content of lithium preferably is, for example, 1 to 15 atomic percent (at %). Examples of the carbon material for use in the negative electrode active material include artificial graphite, natural graphite, low-crystalline carbon, coke, and anthracite.

Preferred as lithium titanate for use in the negative electrode active material is lithium titanate expressed by a general formula of LiₓTi_{y}O₄, where the stoichiometric numbers of x and y satisfy 0.8≦x≦1.4 and 1.6≦y≦2.2, respectively. Particularly, lithium titanate having stoichiometric numbers of x=1.33 and y=1.67 is preferred. The lithium titanate expressed by the above-described general formula of LiₓTi_{y}O₄ can be obtained by, for example, subjecting titanium oxide and a lithium compound to heat treatment at 760 to 1100° C. As the foregoing titanium oxide, both of the anatase type and the rutile type of the same can be used. As the foregoing lithium compound, for example, lithium hydroxide, lithium carbonate, lithium oxide, or the like can be used.

In the case where the negative electrode active material is lithium or lithium alloy, the material alone may form the negative electrode. Alternatively, the negative electrode may be formed by applying lithium or lithium alloy over a charge collector such as a metal wire net by compression bonding. On the other hand, in the case where a carbon material or lithium titanate is used as the negative electrode active material, the negative electrode may be formed, for example, through the following steps: preparing a negative electrode mixture by mixing the carbon material or lithium titanate as the negative electrode active material, and a conductive agent additionally as required; and subjecting the negative electrode mixture thus prepared to pressure forming. Alternatively, the negative electrode may be formed through the following steps: preparing a negative electrode mixture-containing paste by dispersing a negative electrode mixture in water or an organic solvent (in this case, the negative electrode mixture-containing paste may be prepared by dissolving or dispersing a binder in water or the solvent preliminarily and mixing the obtained solution or dispersion with the negative electrode active material or the like); applying the negative electrode mixture-containing paste over a charge collector formed with a metal foil, an expanded metal, or a plain-woven metal wire net; drying the paste applied over the charge collector; and thereafter, subjecting the same to pressure forming. The method for forming the negative electrode, however, is not limited to the above-described ones: the negative electrode may be formed by another method.

It should be noted that as the binder and the conductive agent for forming the negative electrode, the above-described binders and conductive agents of various types for forming the positive electrode can be used.

In the case where a carbon material is used in the negative electrode active material, a composition of the negative electrode preferably is such that, for example, the content of the carbon material is 80 to 95 mass %, the content of the binder is 5 to 20 mass % with respect to the total amount by mass of the negative electrode mixture that forms the negative electrode. In the case where a conductive agent is used additionally, the composition of the negative electrode preferably is such that the carbon material is 75 to 90 mass %, the content of the conductive agent is 5 to 20 mass %, and the content of the binder is 3 to 15 mass %. On the other hand, in the case where lithium titanate is used in the negative electrode active material, the composition of the negative electrode preferably is such that lithium titanate is 80 to 95 mass % and the content of the binder is 5 to 20 mass % with respect to the total amount by mass of the negative electrode mixture that forms the negative electrode. In the case where a conductive agent is used additionally, the composition of the negative electrode preferably is such that the content of lithium titanate is 75 to 90 mass %, the content of the conductive agent is 5 to 20 mass %, and the content of the binder is 3 to 15 mass %.

As the separator, a microporous resin film or a resin nonwoven fabric can be used. Examples of the material of the foregoing resin film or resin fabric include polyolefins such as polyethylene (PE), polypropylene (PP), and polymethylpentene. Apart from these, examples of the same include, as those imparting thermal resistance, fluorocarbon resins such as tetrafluoroethylene-perfluoroalkoxyethylene copolymer (PFA); polyphenylene sulfide (PPS); polyether ether ketone (PEEK); and polybutylene terephthalate (PBT). A separator may be formed by laminating a plurality of the microporous resin films and resin nonwoven fabrics that are made of the foregoing materials, or laminating a plurality of the microporous resin films alone or a plurality of the resin nonwoven fabrics alone.

As the outer case that is to function as the negative electrode terminal, a case made of, for example, stainless steel or iron can be used (preferably at least a surface thereof in contact with the electrode is plated with nickel).

Examples of the material for forming the ring-shaped gasket include PP; nylon (nylon 6, nylon 66, etc.). Apart from these, examples of the same include, as those imparting thermal resistance, fluorocarbon resins such as PFA; polyphenylene ether (PPE); polysulfone (PSF); polyarylate (PAR); polyether sulfone (PES); PPS; and PEEK.

As the non-aqueous electrolytic solution, for example, an electrolytic solution prepared by dissolving an electrolyte (lithium salt) in an organic solvent so that the concentration of the electrolyte is around 0.3 to 2.0 mol/L may be used. Examples of the organic solvent include cyclic carbonic acid esters such as ethylene carbonate (EC), propylene carbonate, butylene carbonate, and vinylene carbonate; chain carbonic acid esters such as dimethyl carbonate, diethyl carbonate (DEC), and methyl ethyl carbonate; ethers such as diglyme (diethylene glycol methyl ether), triglyme (triethylene glycol dimethyl ether), tetraglyme (tetraethylene glycol dimethyl ether), 1,2-dimethoxy ethane, 1,2-diethoxy methane, and tetrahydrofuran. Each of the above-described organic solvents may be used alone, or two or more of the same may be used in combination.

Examples of the electrolyte include lithium salts such as LiBF₄, LiPF₆, LiAsF₆, LiSbF₆, LiClO₄, LiCF₃SO₃, LiC₄F₉SO₃, LiN(CF₃SO₂)₂, and LiN(C₂F₅SO₂)₂.

In the case where a non-aqueous electrolytic solution prepared by using a fluorine-atom-containing lithium salt such as LiBF₄, LiPF₆, LiAsF₆, LiSbF₆, LiCF₃SO₃, LiC₄F₉SO₃, LiN(CF₃SO₂)₂, or LiN(C₂F₅SO₂)₂ is used in a battery, as described above, hydrogen fluoride is generated owing to moisture inevitably mixed during the battery manufacturing process or the like, and this sometimes impairs the leakage resistance of the battery. Therefore, as shown in FIG. 2, the sealing plate 1 preferably has, at a periphery thereof, a shoulder part 15 lower in a step-like form with respect to the top surface 14 of the sealing plate 1, and in addition to this, a wall part extending downward from the shoulder part 15 and terminating at an end part 13.

The flat-shaped non-aqueous electrolyte secondary battery of the present invention can exhibit excellent leakage resistance for a long time, and therefore, it can be used suitably as a power source to be used continuously for a long time, like a power source for a portable timepiece such as a watch, as well as for various applications in which conventional flat-shaped non-aqueous electrolyte secondary batteries have been used.

The following will describe the present invention in more detail while referring to Examples.

### EXAMPLE 1

Production of Positive Electrode

A positive electrode mixture was prepared by mixing LiCoO₂ as a positive electrode active material, carbon black as a conductive agent, and PVDF as a binder at a ratio by mass of LiCoO₂: carbon black: PVDF=85:10:5. The positive electrode mixture was subjected to pressure forming so that a positive electrode having a diameter of 8 mm and a thickness of 0.7 mm was formed. This positive electrode was configured so as to exhibit an open circuit voltage of not less than 3.5 V measured by using metal lithium as a counter electrode in a state where the battery was charged.

Production of Negative Electrode

A negative electrode mixture was prepared by mixing lithium titanate (Li_{1.33}Ti_{1.67}O₄) as a negative electrode active material, carbon black and graphite as conductive agents, and PTFE as a binder at a ratio by mass of lithium titanate : carbon black : graphite : PTFE=85:5:5:5. This negative electrode mixture was subjected to pressure forming, whereby a negative electrode having a diameter of 8.5 mm and a thickness of 0.7 mm was formed.

Assembly of Battery

An electrode body formed by opposing the foregoing positive electrode and the foregoing negative electrode with a separator being interposed therebetween, and a non-aqueous electrolytic solution were confined in a sealed space formed by a sealing plate, an outer case, and a ring-shaped gasket, whereby a flat-shaped non-aqueous electrolyte secondary battery having a diameter of 12.5 mm and a height of 2.0 mm, and having the structure shown in FIG. 2, was produced.

For forming the sealing plate 1 that was to function as a positive electrode terminal, a clad material formed with a metal lamination composed of a first metal layer 12 made of aluminum and a second metal layer 11 made of stainless steel was used in a manner such that the first metal layer 12 of the clad material, made of aluminum, came on an internal side of the battery, and was formed so as not to have a fold-back part at the periphery. For forming the outer case 2 that was to function as a negative electrode terminal, a case that was formed with stainless steel and was plated with nickel was used.

As the separator 4, a PP nonwoven fabric was used. As a ring-shaped gasket 6, a gasket made of PP was used. As a non-aqueous electrolytic solution, a solution was used which was prepared by dissolving LiPF₆ in a mixture solvent obtained by mixing DEC and EC at a ratio by volume of 1:1 so that the concentration of LiPF₆ was 1.0 mol/L.

The following describes the flat-shaped non-aqueous electrolyte secondary battery of Example 1 while referring to FIG. 2. A positive electrode 3 was formed by preparing a positive electrode mixture containing LiCoO₂ as a positive electrode active material and subjecting the positive electrode mixture to pressure forming. A negative electrode 5 was formed by preparing a negative electrode mixture containing lithium titanate as a negative electrode active material and subjecting the negative electrode mixture to pressure forming. Between the positive electrode 3 and the negative electrode 5, the separate 4 made of a PP nonwoven fabric was interposed, whereby an electrode body was formed. This electrode body and non-aqueous electrolytic solution (not shown) were confined in a sealed space formed by a sealing plate 1, an outer case 2, and the ring-shaped gasket 6. In the assembling process of the battery, an end part of the outer case 2 around the opening thereof was crimped inward so that the ring-shaped gasket 6 was subjected to pressure welding against the sealing plate 1 and the outer case 2, whereby the opening of the outer case 2 was sealed so that an internal part of the battery was made in a sealed state.

### EXAMPLE 2

A flat-shaped non-aqueous electrolyte secondary battery having the structure shown in FIG. 1 was produced in the same manner as that for Example 1 except that a sealing plate having a fold 16 at a periphery was used as the sealing plate 1 that was to function as the positive electrode terminal.

### COMPARATIVE EXAMPLE 1

A flat-shaped non-aqueous electrolyte secondary battery having the structure shown in FIG. 3 was produced. As the sealing plate 1, the following sealing plate was used: a sealing plate that was made of stainless steel and plated with nickel, and was formed in a shape having a fold at a periphery. This sealing plate 1 was to function as a negative electrode terminal. For forming an outer case 2, a clad material formed with a metal lamination composed of a first metal layer 22 made of aluminum and a second metal layer 21 made of stainless steel was used in a manner such that the first metal layer 22 of the clad material, made of aluminum, came on an internal side of the battery. This outer case 2 was to function as a positive electrode terminal. As a positive electrode 3, a separator 4, a negative electrode 5, and a non-aqueous electrolytic solution, the same ones as those used in Example 1 were used. In other words, in the battery of Comparative Example 1, the positions of the positive and negative electrodes were inverted as compared with those in the batteries of Examples 1 and 2.

Evaluation of Leakage Resistance

The flat-shaped non-aqueous electrolyte secondary batteries of Examples 1 and 2 and Comparative Example 1, after charged, were stored in an atmosphere having a temperature of 60° C. and a relative humidity of 90% for 50 days, and whether leakage occurred or not after this storage was checked by visual inspection. The number of batteries used in this test was 25 for each of Examples 1 and 2 and Comparative Example 1. The results of this test are shown in Table 1. In Table 1, in each value shown therein, the denominator represents the total number of batteries tested, and the numerator represents the number of batteries having leakage.

TABLE 1

| | Number of Leaking Batteries/ |
|---|---|
| | Total Number of Batteries |
| Ex. 1 | 0/25 |
| Ex. 2 | 0/25 |
| Comp. Ex. 1 | 8/25 |

As shown in Table 1, no leakage was observed in the batteries of Examples 1 and 2. In contrast, in some of the batteries of Comparative Example 1, leakage was observed, which was from an interface between an aluminum-exposed portion and the ring-shaped gasket 6 in the vicinity of the end part 23 of the outer case 2.

Here, to compare the batteries of Example 1 and those of Example 2, which did not have leakage, the batteries were disassembled so that the end part 13 of each sealing plate 1 was checked. The batteries of Example 1 did not have corrosion at the portion of the first metal layer 12 made of aluminum, whereas some of the batteries of Example 2 had corrosion at the portion of the first metal layer 12 made of aluminum at the end part 13 of the sealing plate 1. Thus, it can be concluded that the batteries of Example 1 had superior leakage resistance to the batteries of Example 2.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A flat-shaped non-aqueous electrolyte secondary battery, comprising:
an electrode body formed by opposing a positive electrode and a negative electrode while interposing a separator therebetween;
an outer case for housing the electrode body; and
a sealing plate for sealing an opening of the outer case,
wherein an end part of the sealing plate is positioned inside the outer case,
wherein
the sealing plate functions as a positive electrode terminal,
the outer case functions as a negative electrode terminal, and
a surface layer of the sealing plate in contact with the positive electrode is formed with a metal layer made of aluminum or aluminum alloy.

2. The flat-shaped non-aqueous electrolyte secondary battery according to claim 1, wherein
the sealing plate is formed with a clad material, the clad material including a first metal layer made of aluminum or aluminum alloy, and a second metal layer made of stainless steel or iron.

3. The flat-shaped non-aqueous electrolyte secondary battery according to claim 1, wherein
the sealing plate includes, at a periphery thereof, a shoulder part lower in a step-like form with respect to a top surface of the sealing plate, and a wall part extending downward from the shoulder part and then folded back at a fold so that the end part of the sealing plate is directed upward.

4. The flat-shaped non-aqueous electrolyte secondary battery according to claim 1, wherein
the sealing plate includes, at a periphery thereof, a shoulder part lower in a step-like form with respect to a top surface of the sealing plate, and a wall part extending downward from the shoulder part and then folded back at a fold so that the end part of the sealing plate is directed upward, and
the sealing plate is formed with a clad material, the clad material including a first metal layer made of aluminum or aluminum alloy, and a second metal layer made of stainless steel or iron.

5. The flat-shaped non-aqueous electrolyte secondary battery according to claim 1, wherein
an open circuit voltage of the positive electrode measured by using metal lithium as a counter electrode in a state where the battery is charged is not less than 3.5 V.

6. A flat-shaped non-aqueous electrolyte secondary battery, comprising:
an electrode body formed by opposing a positive electrode and a negative electrode while interposing a separator therebetween;
an outer case for housing the electrode body;
a sealing plate for sealing an opening of the outer case; and
a non-aqueous electrolytic solution,
wherein an end part of the sealing plate is positioned inside the outer case,
wherein
the sealing plate functions as a positive electrode terminal,
the outer case functions as a negative electrode terminal,
a surface layer of the sealing plate in contact with the positive electrode is formed with a metal layer made of aluminum or aluminum alloy, and
the sealing plate has, at a periphery thereof, a shoulder part lower in a step-like form with respect to a top surface of the sealing plate, and a wall part extending downward from the shoulder part and terminating at the end part of the sealing plate.

7. The flat-shaped non-aqueous electrolyte secondary battery according to claim 6, wherein
the non-aqueous electrolytic solution contains a fluorine-atom-containing lithium salt and an organic solvent.

8. The flat-shaped non-aqueous electrolyte secondary battery according to claim 6, wherein
an open circuit voltage of the positive electrode measured by using metal lithium as a counter electrode in a state where the battery is charged is not less than 3.5 V

9. A flat-shaped non-aqueous electrolyte secondary battery, comprising:
an electrode body formed by opposing a positive electrode and a negative electrode while interposing a separator therebetween;
an outer case for housing the electrode body;
a sealing plate for sealing an opening of the outer case; and
a non-aqueous electrolytic solution,
wherein an end part of the sealing plate is positioned inside the outer case,
wherein
the sealing plate functions as a positive electrode terminal,
the outer case functions as a negative electrode terminal,
the sealing plate is formed with a clad material, the clad material including a first metal layer made of aluminum or aluminum alloy and a second metal layer made of stainless steel or iron,
the first metal layer is in contact with the positive electrode, and
the sealing plate has, at a periphery thereof, a shoulder part lower in a step-like form with respect to a top surface of the sealing plate, and a wall part extending downward from the shoulder part and terminating at the end part of the sealing plate.

10. The flat-shaped non-aqueous electrolyte secondary battery according to claim 9, wherein
the non-aqueous electrolytic solution contains a fluorine-atom-containing lithium salt and an organic solvent.

11. The flat-shaped non-aqueous electrolyte secondary battery according to claim 9, wherein
an open circuit voltage of the positive electrode measured by using metal lithium as a counter electrode in a state where the battery is charged is not less than 3.5 V.
